(19) United States
(12) Patent Application Publication
(10) Pub. No.: US 2018/0272537 A1
(43) Pub. Date: Sep. 27, 2018

(54) ROBOT CONTROL DEVICE, ROBOT, AND ROBOT SYSTEM

(71) Applicant: Seiko Epson Corporation, Tokyo (JP)

(72) Inventors: Toshiyuki ISHIGAKI, Sakata (JP); Naoki UMETSU, Mikawa (JP)

(21) Appl. No.: 15/916,853

(22) Filed: Mar. 9, 2018

(30) Foreign Application Priority Data
Mar. 27, 2017 (JP) 2017-060598

(51) Int. Cl. B25J 9/16; G05B 19/401; G06T 7/73

(52) U.S. Cl. CPC B25J 9/1692; G05B 2219/39024; G06T 7/74; G05B 19/401

(57) ABSTRACT

A robot control device detects a detection target position, which is a position of a detection target, from a first image obtained by causing a first camera disposed in a first robot to image the detection target. The robot control device includes a control unit that detects the detection target position from the first image, and that corrects the detection target position, based on first reference position information stored in advance in a storage unit and indicating a first reference position which is a reference position of a first reference marker, and first detection position information indicating a first detection position which is a position detected based on the first image and which is a position of the first reference marker included in the first image.

### BACKGROUND

### 1. Technical Field

The present invention relates to a robot control device, a robot, and a robot system.

### 2. Related Art

Techniques for causing a robot to carry out predetermined work based on an image captured by an imaging unit have been researched and developed.

In this regard, a robot is known which carries out work on a target, based on a determined position by determining the position of the target, based on an image captured by a camera included in an arm of the robot, in which the captured image is obtained by imaging a marker disposed in the target (refer to JP-T-2011-502807).

Here, according to a robot in the related art, when a target is imaged using a camera, a position of the camera is aligned with a predetermined imaging position. However, when the target is imaged using the camera in the robot, in some cases, the imaging position is misaligned with the position of the camera due to insufficient rigidity of an arm or insufficient rigidity caused by an attachment structure of the camera attached to the arm. As a result, in some cases, the robot cannot carry out highly accurate work on the target.

### SUMMARY

An aspect of the invention is directed to a robot control device for detecting a detection target position, which is a position of a detection target, from a first image obtained by causing a first imaging unit disposed in a first robot to image the detection target. The robot control device includes a control unit that detects the detection target position from the first image, and that corrects the detection target position, based on first reference position information stored in advance in a storage unit and indicating a first reference position which is a reference position of a first reference marker, and first detection position information indicating a first detection position which is a position detected based on the first image and which is a position of the first reference marker included in the first image.

According to this configuration, the robot control device detects the detection target position, which is the position of the detection target, from the first image obtained by causing the first imaging unit disposed in the first robot to image the detection target. The robot control device corrects the detection target position, based on the first reference position information stored in advance in the storage unit and indicating the first reference position which is the reference position of the first reference marker, and the first detection position information indicating the first detection position which is the position detected based on the first image and which is the position of the first reference marker included in the first image. In this manner, the robot control device can perform highly accurate processing, based on the corrected detection target position.

In another aspect of the invention, the robot control device may be configured such that the first reference position is a position in a first coordinate system, and the control unit converts the first detection position into the position in the first coordinate system, and corrects the detection target position, based on a difference between the converted first detection position and the first reference position.

According to this configuration, the robot control device converts the first detection position into the position in the first coordinate system, and corrects the detection target position, based on the difference between the converted first detection position and the first reference position. In this manner, the robot control device can perform highly accurate processing, based on the difference between the first detection position converted into the position in the first coordinate system and the first reference position, and based on the corrected detection target position.

In another aspect of the invention, the robot control device may be configured such that a height of the first reference marker is equal to a height of the detection target position.

According to this configuration, in the robot control device, the height of the first reference position is equal to the height of the detection target position. In this manner, the robot control device can suppress an error based on the difference between the height of the first reference marker and the height of the detection target position, in errors occurring when the detection target position is detected from the first image.

In another aspect of the invention, the robot control device may be configured such that the control unit causes a second robot to carry out work at a work position based on the detection target position.

According to this configuration, the robot control device causes the second robot to carry out the work at the work position based on the detection target position. In this manner, the robot control device can cause the second robot to carry out highly accurate work.

In another aspect of the invention, the robot control device may be configured such that the control unit corrects the work position, based on second reference position information stored in advance in the storage unit and indicating a second reference position which is a reference position of a second reference marker, and a second detection position information indicating a second detection position which is a position detected based on a second image captured by a second imaging unit disposed in the second robot and which is a position of the second reference marker included in the second image.

According to this configuration, the robot control device corrects the work position, based on the second reference position information stored in advance in the storage unit and indicating the second reference position which is the reference position of the second reference marker, and the second detection position information indicating the second detection position which is the position detected based on the second image captured by the second imaging unit disposed in the second robot and which is the position of the second reference marker included in the second image. In this manner, the robot control device can cause the second robot to carry out highly accurate work, based on the corrected work position.

In another aspect of the invention, the robot control device may be configured such that, in a case where the control unit causes the second robot to carry out the work multiple times, the control unit corrects the work position less number of times than the multiple times.

According to this configuration, in the case where the control unit causes the second robot to carry out the work multiple times, the robot control device corrects the work position less number of times than the multiple times. In this manner, the robot control device can shorten a time required for work to be repeatedly carried out by the second robot.

In another aspect of the invention, the robot control device may be configured such that the control unit determines whether or not a posture of an imaging unit is a predetermined posture, based on an image obtained by causing the imaging unit to image a first calibration marker and a second calibration marker located at a position different from a position of the first calibration marker in an imaging direction of the imaging unit connected to the robot control device.

According to this configuration, the robot control device determines whether or not the posture of the imaging unit is the predetermined posture, based on the image obtained by causing the imaging unit to image the first calibration marker and the second calibration marker located at the position different from the position of the first calibration marker in the imaging direction of the imaging unit connected to the robot control device. In this manner, the robot control device can assist posture adjustment of the imaging unit connected to the robot control device.

In another aspect of the invention, the robot control device may be configured such that the first calibration marker is disposed on a first surface of an object, and the second calibration marker is disposed on a second surface different from the first surface of the object.

According to this configuration, in the robot control device, the first calibration marker is disposed on the first surface of the object. The second calibration marker is disposed on the second surface different from the first surface of the object. In this manner, the robot control device can assist posture adjustment of the imaging unit connected to the robot control device, based on the first calibration marker disposed on the first surface of the object and the second calibration marker disposed on the second surface of the object.

In another aspect of the invention, the robot control device may be configured such that a distance between the first calibration marker and the second calibration marker is equal to or longer than half of a depth of field of the imaging unit, and is equal to or shorter than twice the depth of field of the imaging unit.

According to this configuration, in the robot device, the distance between the first calibration marker and the second calibration marker is equal to or longer than half of the depth of field of the imaging unit, and is equal to or shorter than twice the depth of field of the imaging unit connected to the robot control device. In this manner, the robot control device can assist posture adjustment of the imaging unit connected to the robot control device, based on the second calibration marker located away from the first calibration marker as far as a distance equal to or longer than half of the depth of field of the imaging unit connected to the robot control device and equal to or shorter than twice the depth of field of the imaging unit, and the first calibration marker.

Another aspect of the invention is directed to a robot which is the first robot controlled by the robot control device described above.

According to this configuration, the robot detects the detection target position, which is the position of the detection target, from the first image obtained by causing the first imaging unit disposed in the first robot to image the detection target. The robot corrects the detection target position, based on the first reference position stored in advance and the position of the first reference marker indicating the first reference position included in the first image. In this manner, the robot can perform highly accurate processing, based on the corrected detection target position.

Another aspect of the invention is directed to a robot system including the robot control device described above and a robot which is the first robot controlled by the robot control device.

According to this configuration, the robot system detects the detection target position, which is the position of the detection target, from the first image obtained by causing the first imaging unit disposed in the first robot to image the detection target. The robot system corrects the detection target position, based on the first reference position stored in advance and the position of the first reference marker indicating the first reference position included in the first image. In this manner, the robot system can perform highly accurate processing, based on the corrected detection target position.

As described above, the robot control device, the robot, and the robot system detect the detection target position, which is the position of the detection target, from the first image obtained by causing the first imaging unit disposed in the first robot to image the detection target. The robot control device, the robot, and the robot system correct the detection target position, based on the first reference position information stored in advance in the storage unit and indicating the first reference position which is the reference position of the first reference marker, and the first detection position information indicating the first detection position which is the position detected based on the first image and which is the position of the first reference marker included in the first image. In this manner, the robot control device, the robot, and the robot system can perform highly accurate processing, based on the corrected detection target position.

### BRIEF DESCRIPTION OF THE DRAWINGS

The invention will be described with reference to the accompanying drawings, wherein like numbers reference like elements.

FIG. 1 is a view illustrating an example of a configuration of a robot system according to an embodiment.

FIG. 2 is a view illustrating an example of a hardware configuration of a robot control device.

FIG. 3 is a view illustrating an example of a functional configuration of the robot control device.

FIG. 4 is a top view illustrating an example of a calibration object.

FIG. 5 is a side view in a case where the calibration object is viewed in a positive direction of a Y-axis in a three-dimensional orthogonal coordinate system illustrated in FIG. 4.

FIG. 6 is a view for describing a method of adjusting a posture of a first imaging unit and a posture of a second imaging unit.

FIG. 7 is a view illustrating an example of a third image.

FIG. 8 is a view illustrating an example of a fourth image.

FIG. 9 is a graph illustrating an example of a relationship between a distance from a first surface of the calibration object, which is a distance in a direction from the first surface toward a second surface of the calibration object, and a Y-coordinate indicating a central position of the calibration object imaged by an imaging unit.

FIG. 10 is a flowchart illustrating an example of a process in which the robot control device corrects a detection target position and a work position.

FIG. 11 is a view illustrating an example of a first image acquired by an image acquisition unit in Step S140.

FIG. 12 is a view illustrating an example where a first detection position is misaligned with a first reference position indicated by first reference position information, on an image illustrated in FIG. 11.

### DESCRIPTION OF EXEMPLARY EMBODIMENTS

### Embodiment

Hereinafter, an embodiment according to the invention will be described with reference to the drawings.

Configuration of Robot System.

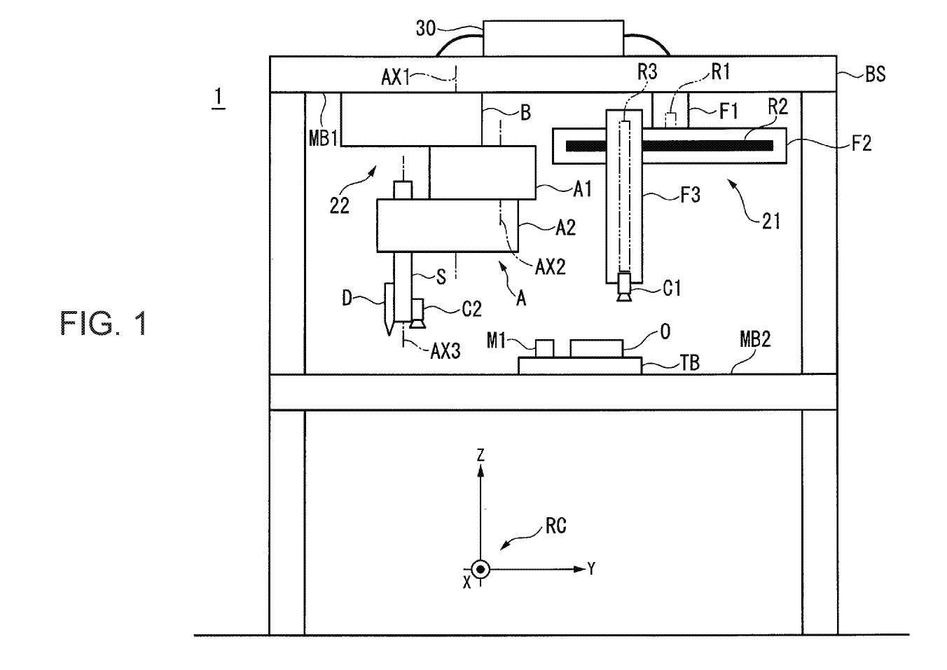

First, referring to FIG. 1, a configuration of a robot system 1 will be described. FIG. 1 is a view illustrating an example of the configuration of the robot system 1 according to the embodiment.

For example, the robot system 1 includes abase frame BS, a first robot 21, a second robot 22, and a robot control device 30. In addition to these, the robot system 1 further includes a transport device (for example, another transporting robot or a belt conveyor) for transporting an object and an imaging unit (that is, a camera separate from each of the first robot 21 and the second robot 22). The robot control device 30 may be configured to be incorporated in any one of the first robot 21 and the second robot 22. In a case where the robot control device 30 is incorporated in the first robot 21, the robot system 1 includes the base frame BS, the first robot 21 having the robot control device 30 incorporated therein, and the second robot 22. In a case where the robot control device 30 is incorporated in the second robot 22, the robot system 1 includes the base frame BS, the first robot 21, and the second robot 22 having the robot control device 30 incorporated therein. The robot system 1 may be configured not to include the base frame BS. In this case, each of the first robot 21 and the second robot 22 is attached to other objects to which the robot can be attached such as a ceiling, a floor surface, and a wall surface.

Hereinafter, for convenience of description, a direction of gravity (vertically downward direction) will be referred to as a downward direction or downward, and a direction opposite to the downward direction will be referred to as an upward direction or upward. Hereinafter, as an example, a case will be described where the upward direction coincides with a positive direction of a Z-axis in a robot coordinate system RC which also serves as a robot coordinate system of the first robot 21 and a robot coordinate system of the second robot 22. Here, the robot coordinate system RC is a three-dimensional orthogonal coordinate system. A configuration may be adopted in which the upward direction does not coincide with the positive direction of the Z-axis in the robot coordinate system RC.

For example, the base frame BS is a metal frame having a rectangular parallelepiped shape. The shape of the base frame BS may be other shapes such as a cylindrical shape instead of the rectangular parallelepiped shape. The material of the base frame BS may be other materials such as a resin instead of the metal. The base frame BS has a flat plate serving as a ceiling plate MB1 on an uppermost portion which is an uppermost end portion of end portions belonging to the base frame BS. A flat plate serving as a floor plate MB2 on which various objects can be placed is disposed between a lowest portion which is the lowest side end portion of the end portions belonging to the base frame BS and the ceiling plate MB1. In the example illustrated in FIG. 1, the upper surface of the floor plate MB2 is a plane parallel to the lower surface of the ceiling plate MB1. The upper surface may not be the plane parallel to the lower surface.

The base frame BS is installed on an installation surface. For example, the installation surface is a floor surface in a room in which the base frame BS is installed. The installation surface may be other surfaces such as a wall surface and a ceiling surface in the room, or an outdoor ground surface instead of the floor surface.

In the robot system 1, the first robot 21 and the second robot 22 are installed in the ceiling plate MB1 of the base frame BS so that work regions at least partially overlap each other inside the base frame BS. The first robot 21 and the second robot 22 are installed in the ceiling plate MB1 of the base frame BS so that a work table TB installed on the upper surface of the floor plate MB2 is included in the work regions at least partially overlapping each other inside the base frame BS. In this manner, the robot system 1 can cause the first robot 21 and the second robot 22 to carry out work which can be performed in cooperation with both the first robot 21 and the second robot 22, which is work to be carried out on the object installed on the upper surface of the work table TB, as predetermined work. In this example, the robot control device 30 causes the first robot 21 to carry out first work in the predetermined work, and causes the second robot 22 to carry out second work in the predetermined work.

In this example, the work table TB is a flat plate installed on the upper surface of the floor plate MB2 serving as a base on which an object O can be mounted as a target of the predetermined work to be carried out in cooperation with the first robot 21 and the second robot 22. The work table TB may be other objects which can be used as the base such as a table and a shelf, instead of the flat plate.

The object O is placed on the upper surface of the work table TB. For example, the object O is an industrial component or member such as a plate, a screw, and a bolt which are to be assembled into a product. In FIG. 1, in order to simplify the illustration, the object O is illustrated as a square flat plate. The object O may be daily necessities or other objects such as living bodies, instead of the industrial component or member. The shape of the object O may be other flat plate shapes instead of the square flat plate shape, or the object having a shape different from the flat plate shape may be used. In this example, a position of the object O is represented by a centroid position of the upper surface of the object O. The centroid of the upper surface is the centroid of the drawing representing the shape of the upper surface. The position of the object O may be other positions on the upper surface, or may be other positions associated with the object O.

Here, the work region of the first robot 21 is a region where the first robot 21 can carry out the work. The work region of the second robot 22 is a region where the second robot 22 can carry out the work. The position where the first robot 21 is installed inside the base frame BS may be other positions of the base frame BS, instead of the ceiling plate MB1. In this case, the second robot 22 is installed at a position corresponding to the position where the first robot 21 is installed. The work region of the first robot 21 may include the outside of the base frame BS. The work region of the second robot 22 may include the outside of the base frame BS. In the robot system 1, as long as the first robot 21 and the second robot 22 are configured to be installed so that the work regions at least partially overlap each other, a configuration may be adopted in which the first robot 21 and the second robot 22 are installed in the object other than the ceiling plate MB1 of the base frame BS. The first robot 21 and the second robot 22 may be configured to be installed in mutually different objects.

For example, the first robot 21 is an orthogonal coordinate robot (gantry robot). The first robot 21 may be a vertically articulated robot such as a single-arm robot having one arm, a dual-arm robot having two arms, a multi-arm robot having three or more arms, instead of the orthogonal coordinate robot, or may be a scara robot (a horizontally articulated robot). Alternatively, other robots such as a cylindrical robot may be used.

The first robot 21 includes a first frame F1, a second frame F2, a third frame F3, and a first imaging unit C1.

The first frame F1 supports the second frame F2, and is attached so as not to move to the object where the first robot 21 is installed. The object is the ceiling plate MB1 in this example. For example, the first frame F1 is a member having a rectangular parallelepiped shape. The first frame F1 may be a member having other shapes instead of the member having rectangular parallelepiped shape. A rail R1 is formed along a longitudinal direction of the rectangular parallelepiped shape on a surface opposite to a surface in contact with the lower surface of the ceiling plate MB1 in the surfaces belonging to the first frame F1. In the following description, as an example, a case will be described where the first frame F1 is installed in the ceiling plate MB1 so that the longitudinal direction and a direction along an X-axis in the robot coordinate system RC are parallel to each other. The longitudinal direction and the direction along the X-axis may not be parallel to each other.

The second frame F2 is supported by the first frame F1, supports the third frame F3, and is translatable along the rail R1 by a linear actuator (not illustrated). For example, the second frame F2 is a member having a rectangular parallelepiped shape. The second frame F2 may be a member having other shapes, instead of the member having rectangular parallelepiped shape. A rail R2 is formed along the longitudinal direction of the rectangular parallelepiped shape on a surface opposite to the surface facing the first frame F1 side in the surfaces belonging to the second frame F2. In the following description, as an example, a case will be described where the second frame F2 is supported by the first frame F1 so that the longitudinal direction and a direction along a Y-axis in the robot coordinate system RC are parallel to each other. The longitudinal direction and the direction along the Y-axis may not be parallel to each other.

The third frame F3 is supported by the second frame F2, and is translatable along the rail R2 by a linear actuator (not illustrated). For example, the third frame F3 is a member having a rectangular parallelepiped shape. The third frame F3 may be a member having other shapes, instead of the member having the rectangular parallelepiped shape. A rail R3 is formed along the long direction of the rectangular parallelepiped shape on the surface facing the second frame F2 side in the surfaces belonging to the third frame F3. In the following description, as an example, a case will be described where the third frame F3 is supported by the second frame F2 so that the longitudinal direction and a direction along a Z-axis in the robot coordinate system RC are parallel to each other. Third frame F3 is translatable in the direction along the rail R3 by a linear actuator (not illustrated). The longitudinal direction and the direction along the Z-axis may not be parallel to each other.

In this way, in each of the first frame F1, the second frame F2, and the third frame F3 in this example, the longitudinal directions are orthogonal to each other. The second frame F2 is translatable in the direction along the rail R1, and the third frame F3 is translatable in the direction along each of the rail R2 and the rail R3. In this manner, the first robot 21 can move a position of a lower side end portion in the end portions belonging to the third frame F3 to a position instructed by the robot control device 30.

For example, the first imaging unit C1 is a camera including a charge coupled device (CCD) or complementary metal oxide semiconductor (CMOS) which is an imaging element for converting condensed light into an electric signal. The first imaging unit C1 is a camera having a telecentric lens. The first imaging unit C1 may be a camera having other lenses, instead of the telecentric lens. In this example, the first imaging unit C1 is included in the lower side end portion in the end portions belonging to the third frame F3. Therefore, the first imaging unit C1 moves in response to the movement of the end portion. A range in which the first imaging unit C1 can capture an image varies in response to the movement of the third frame F3. The first imaging unit C1 captures a two-dimensional image in the range. The first imaging unit C1 may be configured to capture a three-dimensional image in the range. In this case, the first imaging unit C1 is a stereo camera or a light field camera. The first imaging unit C1 may be configured to capture a still image in the range, or may be configured to capture a moving image in the range. In the following description, as an example, a case will be described where the first imaging unit C1 captures the still image in the range. In this example, a position of the first imaging unit C1 is represented by a position in the robot coordinate system RC which is an origin of a first imaging unit coordinate system (not illustrated) serving as a three-dimensional orthogonal coordinate system associated with a position of the center of gravity of the first imaging unit C1. A posture of the first imaging unit C1 is represented by a direction in the robot coordinate system RC of each coordinate axis in the first imaging unit coordinate system.

The first imaging unit C1 is connected to and communicable with the robot control device 30 via a cable. Wired communication via the cable is performed according to standards such as the Ethernet (registered trademark) and a USB, for example. The first imaging unit C1 may be configured to be connected to the robot control device 30 by wireless communication performed according to communication standards such as Wi-Fi (registered trademark).

The second robot 22 is a scara robot (horizontally articulated robot) including a support base B, a movable unit A supported by the support base B, a second imaging unit C2, and a discharge unit D. The second robot 22 may be other robots such as the above-described vertically articulated robot, cartesian coordinate robot, and cylindrical robot, instead of the scara robot.

The support base B supports the moving unit A, and is attached so as not to move to the object where the second robot 22 is installed. The object is the ceiling plate MB1 in this example.

The movable unit A includes a first arm A1 supported by the support base B so as to be pivotable around a first axis AX1, a second arm A2 supported by the first arm A1 so as to be pivotable around a second axis AX2, and a shaft S supported by the second arm A2 so as to be pivotable around a third axis AX3 and so as to be translatable in the axial direction of the third axis AX3.

The shaft S is a cylindrical shaft body. A ball screw groove and a spline groove (not illustrated) are respectively formed on a circumferential surface of the shaft S. In this example, the shaft S is installed by penetrating an end portion opposite to the first arm A1 in an end portion of the second arm A2 in a first direction which is a direction perpendicular to the lower surface of the ceiling plate MB1 having the support base B installed therein. In the example illustrated in FIG. 1, the first direction coincides with an upward/downward direction. The first direction may be configured not to coincide with the upward/downward direction. The end portion on the lower surface side in the end portions of the shaft S enables an end effector to be attached thereto. The end effector may be capable of gripping the object, or the end effector may be capable of adsorbing the object by using air or magnetism. Other end effectors may be employed.

In this example, the first arm A1 pivots around the first axis AX1, and moves in a second direction. The second direction is orthogonal to the above-described first direction. That is, in this example, the second direction extends along an XY-plane in the robot coordinate system RC. The first arm A1 is caused to pivot around the first axis AX1 by a first motor (not illustrated) included in the support base B.

In this example, the second arm A2 pivots around the second axis AX2, and moves in the second direction. The second arm A2 is caused to pivot around the second axis AX2 by a second motor (not illustrated) included in the second arm A2. The second arm A2 includes a third motor (not illustrated) and a fourth motor (not illustrated), and supports the shaft S. The third motor moves (lifts and lowers) the shaft S in the first direction by using a timing belt so that a ball screw nut disposed on an outer peripheral portion of a ball screw groove of the shaft S pivots. The fourth motor causes the shaft S to pivot around the third axis AX 3 by using a timing belt so that a ball spline nut disposed on an outer peripheral portion of a spline groove of the shaft S is caused to pivot.

For example, the second imaging unit C2 is a camera including the CCD or the CMOS which is an imaging element for converting condensed light into an electric signal. The second imaging unit C2 is a camera having a telecentric lens. The second imaging unit C2 may be a camera having other lenses, instead of the telecentric lens. In this example, the second imaging unit C2 together with the discharge unit D is included in the lower side end portion of the shaft S in the end portions belonging to the shaft S. Therefore, the second imaging unit C2 moves in response to the movement of the end portion, that is, movement of the movable unit A. A range in which the second imaging unit C2 can capture an image varies in response to the movement of the movable unit A. The second imaging unit C2 captures a two-dimensional image in the range. The second imaging unit C2 may be configured to capture a three-dimensional image in the range. In this case, the second imaging unit C2 is a stereo camera or a light field camera. The second imaging unit C2 may be configured to capture a still image in the range, or may be configured to capture a moving image in the range. In the following description, as an example, a case will be described where the second imaging unit C2 captures the still image in the range. In this example, a position of the second imaging unit C2 is represented by a position in the robot coordinate system RC of an origin of a second imaging unit coordinate system (not illustrated) serving as the three-dimensional orthogonal coordinate system associated with the position of the center of gravity of the second imaging unit C2. A posture of the second imaging unit C2 is represented by a direction in the robot coordinate system RC of each coordinate axis in the second imaging unit coordinate system.

The second imaging unit C2 is connected to and communicable with the robot control device 30 via a cable. Wired communication via the cable is performed according to standards such as the Ethernet (registered trademark) and a USB, for example. The second imaging unit C2 may be connected to the robot control device 30 by wireless communication performed according to communication standards such as Wi-Fi (registered trademark).

The discharge unit D is a dispenser capable of discharging a discharging target. The discharging target is a substance which can be discharged such as liquid, gas, powder, and granules. In the following description, as an example, a case will be described where the discharging target is grease (lubricant). The discharge unit D includes a syringe portion (not illustrated), a needle portion (not illustrated), and an air injection portion (not illustrated) for injecting air into the syringe portion. The syringe portion is a container having a space for internally containing the grease. The needle portion has a needle for discharging the grease contained in the syringe portion. The needle portion discharges grease from a distal end of the needle. That is, the discharge unit D discharges the grease contained inside the syringe portion from the distal end of the needle portion in such a way that the air injection portion injects the air into the syringe portion. In this example, the discharge unit D together with the second imaging unit C2 is included in the lower side end portion in the end portions belonging to the shaft S. Therefore, a position where the discharge unit D can discharge the discharging target varies in response to the movement of the movable unit A. In this example, a position of the discharge unit D is represented by a position in the robot coordinate system RC of an origin of a discharge unit coordinate system (not illustrated) serving as a three-dimensional orthogonal coordinate system associated with a position of the center of gravity of the discharge unit D. A posture of the discharge unit D is represented by a direction in the robot coordinate system RC of each coordinate axis in the discharge unit coordinate system.

The discharge unit D is connected to and communicable with the robot control device 30 via a cable. Wired communication via the cable is performed according to standards such as the Ethernet (registered trademark) and a USB, for example. The discharge unit D may be connected to the robot control device 30 by wireless communication performed according to communication standards such as Wi-Fi (registered trademark).

The robot control device 30 is a controller that controls each of the first robot 21 and the second robot 22, based on one robot coordinate system RC. In the example illustrated in FIG. 1, the robot control device 30 is installed on the upper surface of the ceiling plate MB1 of the base frame BS. A configuration may be adopted in which the robot control device 30 is installed at other positions of the base frame BS, or a configuration may be adopted in which the robot control device 30 is installed outside the base frame BS.

The robot control device 30 controls each of the first robot 21 and the second robot 22, and causes the first robot 21 and the second robot 22 to carry out predetermined work to be carried out in cooperation with the first robot 21 the second robot 22. Specifically, the robot control device 30 causes the first robot 21 to carry out first work, and causes the second robot 22 to carry out second work.

Overview of Process in which Robot Control Device Causes First Robot and Second Robot to Carry Out Predetermined Work

Hereinafter, an overview of a process in which the robot control device 30 causes the first robot 21 and the second robot 22 to carry out the predetermined work will be described.

In the following description, as an example, the following case will be described. In the robot control device 30, in a state where the position and the posture of the first imaging unit C1 coincide with a predetermined first imaging position and first imaging posture, calibration is performed in advance so as to associate a position on the first image which is an image captured by the first imaging unit C1 and a position in the robot coordinate system RC with each other. In a case where the position and the posture of the first imaging unit C1 coincide with the first imaging position and the first imaging posture, the first imaging position and the first imaging posture are the position and the posture where the first imaging unit C1 can capture an image in a first imaging range which is a range including the upper surface of the work table TB. The robot control device 30 may have a configuration in which the calibration is not performed in advance. In this case, the robot control device 30 performs the calibration before the robot control device 30 performs a process to be described below.

In the following description, as an example, the following case will be described. In the robot control device 30, in a state where the position and the posture of the second imaging unit C2 coincide with a predetermined second imaging position and second imaging posture, calibration is performed in advance so as to associate a position on the second image which is an image captured by the second imaging unit C2 and a position in the robot coordinate system RC with each other. In a case where the position and the posture of the second imaging unit C2 coincide with the second imaging position and the second imaging posture, the second imaging position and the second imaging posture are the position and the posture where the second imaging unit C2 can capture an image in a second imaging range which is a range including the upper surface of the work table TB. The robot control device 30 may have a configuration in which the calibration is not performed in advance. In this case, the robot control device 30 performs the calibration before the robot control device 30 performs a process to be described below.

The second imaging position may be the same as the first imaging position, and may be different from the first imaging position. In the following description, as an example, a case will be described where the second imaging position is the same as the first imaging position. The second imaging posture may be the same as the first imaging posture, and may be different from the first imaging posture. In the following description, as an example, a case will be described where the second imaging posture is the same as the first imaging posture.

The robot control device 30 operates the first robot 21 so that the position and the posture of the first imaging unit C1 coincide with the first imaging position and the first imaging posture. As the first work, the robot control device 30 causes the first robot 21 to carry out the work in which the first imaging unit C1 captures the image in the first imaging range which is the range including the upper surface of the work table TB. The robot control device 30 detects a detection target position which is a position of a detection target, from the first image obtained by causing the first imaging unit C1 to capture the image in the first imaging range. In this example, the detection target is the above-described object O. The detection target may be other objects instead of the object O.

As illustrated in FIG. 1, a first reference marker M1 is disposed on the upper surface of the work table TB. The first reference marker indicates a position of the first reference marker M1. The first reference marker M1 may be any marker as long as the position of the first reference marker M1 is indicated. In the example illustrated in FIG. 1, in order to simplify the drawing, the first reference marker M1 is illustrated as an object having a rectangular parallelepiped shape. The first reference marker M1 may have other shapes capable of indicating the position of the first reference marker, instead of the rectangular parallelepiped shape. The first reference marker M1 may be a sheet-shaped object such as a seal, instead of the object having the rectangular parallelepiped shape. Here, for example, the position of the first reference marker M1 is a position of the centroid of the upper surface of the first reference marker M1. Here, the centroid of the upper surface is the centroid of the drawing illustrating the shape of the upper surface. The position of the first reference marker M1 may be other positions on the upper surface or other positions associated with the first reference marker M1.

A configuration may be adopted in which a second reference marker different from the first reference marker M1 is disposed together with the first reference marker M1 on the upper surface of the work table TB. In the following description, as an example, a case will be described where only the first reference marker M1 is disposed on the upper surface of the work table TB. That is, in this example, the first reference marker M1 and the second reference marker are the same as each other.

The first reference marker M1 is installed in the work table TB so as not to move with respect to the work table TB. The work table TB is installed on the floor plate MB2 so as not to move with respect to the floor plate MB2 of the base frame BS. Therefore, the first reference marker M1 installed in the work table TB does not move in response to the operation of the first robot 21. The first reference marker M1 installed in the work table TB does not move in response to the operation of the second robot 22. In other words, the first reference marker M1 installed in the work table TB is the object which does not move relative to the robot coordinate system RC. Therefore, the position of the first reference marker M1 installed in the work table TB is the position which does not move relative to the robot coordinate system RC.

Here, in the robot control device 30, first reference position information is stored in advance. The first reference position information indicates the first reference position. The first reference position is located at the position in the robot coordinate system RC, and does not move relative to the robot coordinate system RC. Accordingly, the first reference position is the reference position of the first reference marker M1 installed in the work table TB.

The robot control device 30 detects the position of the object O as the detection target position, based on the first image obtained by imaging the object O. The robot control device 30 converts the detected detection target position into a position in the robot coordinate system RC. If an error occurring due to the aberration of the lens of the first imaging unit C1 is sufficiently small, the detection target position converted to the position in the robot coordinate system RC has to substantially coincide with the actual position of the object O, that is, the position of the object O in the robot coordinate system. However, in some cases, the position and the posture of the first imaging unit C1 when the first imaging range is imaged are misaligned with the first imaging position and the first imaging posture due to reasons such as insufficient rigidity of a member configuring the first robot 21 (for example, each of the first frame F1 to the third frame F3), insufficient rigidity associated with an attachment structure of the first imaging unit C1 attached to the first robot 21, and thermal expansion of each actuator included in the first robot 21. Therefore, even if the error occurring due to the aberration of the lens of the first imaging unit C1 is sufficiently small, the detection target position converted to the position in the robot coordinate system RC is misaligned with the actual position of the object O in the robot coordinate system RC, in some cases. As a result, in some cases, the robot control device 30 cannot cause the first robot 21 and the second robot 22 to respectively carry out highly accurate work on the object O.

Therefore, as the first detection position, the robot control device 30 detects the position of the first reference marker M1 included in the first image, based on the first image. The robot control device 30 corrects the detection target position converted into the position in the robot coordinate system RC, based on the first detection position information indicating the detected first detection position and the first reference position information stored in advance. More specifically, the robot control device 30 converts the first detection position to the position in the robot coordinate system RC, and corrects the detection target position, based on a difference between the first detection position converted into the position in the robot coordinate system RC and the first reference position indicated by the first reference position information stored in advance. In this manner, the robot control device 30 enables the detection target position corrected by the robot control device 30 to substantially coincide with the actual position of the object O in the robot coordinate system. Based on the difference between the first detection position converted into the position in the robot coordinate system RC and the first reference position, the robot control device 30 can perform a highly accurate process based on the corrected detection target position. As a result, the robot control device 30 can cause the first robot 21 and the second robot 22 to respectively carry out highly accurate work on the object O.

Instead of a configuration where the first detection position is converted into the position in the robot coordinate system RC, the robot control device 30 may adopt a configuration in which the first reference position indicated by the first reference position information stored in advance is converted into the position on the first image. In this case, the robot control device 30 does not convert the detection target position before the correction is performed into the position in the robot coordinate system RC. In the robot control device 30, the robot control device 30 corrects the detection target position detected from the first image, based on the difference between the detected first detection position and the first reference position converted into the position on the first image. Thereafter, the robot control device 30 converts the corrected detection target position into the position in the robot coordinate system RC.

Instead of a configuration in which the robot control device 30 corrects the detection target position converted into the position in the robot coordinate system RC, based on the difference between the first detection position converted into the position in the robot coordinate system RC and the first reference position indicated by the first reference position information stored in advance, a configuration may be adopted in which the robot control device 30 corrects the detection target position by using other methods based on the first detection position information and the first reference position information.

After the robot control device 30 corrects the detection target position, the robot control device 30 operates the first robot 21, and moves the first imaging unit C1 to a region which does not overlap the work region of the second robot 22, within the work region of the first robot 21. Thereafter, the robot control device 30 operates the second robot 22, and causes the position and the posture of the second imaging unit C2 to coincide with the second imaging position and the second imaging posture (in this example, the first imaging position and the first imaging posture). The robot control device 30 causes the second imaging unit C2 to capture the image in the second imaging range including the upper surface of the work table TB.

The robot control device 30 corrects a work position, based on the second reference position information (in this example, the first reference position information) indicating the second reference position (in this example, the first reference position) serving as the reference position of the second reference marker (in this example, the first reference marker M1) which is the information stored in advance, and the second detection position information indicating the second detection position serving as the position of the second reference marker included in the second image, which is the position detected based on the second image captured by the second imaging unit C2 disposed in the second robot 22. The work position represents a predetermined position, and means a position with the position of the discharge unit D is caused to coincide when the second robot 22 carries out the work. That is, in this example, the second work described above is to discharge the grease onto the upper surface of the object O by using the discharge unit D. Instead of this work, the second work may be another work.

Here, similarly to a case where the position and the posture of the first imaging unit C1 are misaligned with the first imaging position and the first imaging posture, the position of the discharge unit D when the grease is discharged from the discharge unit D onto the upper surface of the object O may be misaligned with the work position, in some cases, due to reasons such as insufficient rigidity of a member configuring the second robot 22 (for example, each of the first arm A1, the second arm A2, and the shaft S), insufficient rigidity associated with an attachment structure of the second imaging unit C2 attached to the second robot 22, and thermal expansion of each actuator included in the second robot 22. Therefore, in some cases, the robot control device 30 cannot discharge the grease to a predetermined position on the upper surface of the object O by operating the second robot 22. The above-described correction of the work position is a process performed in order to solve this problem. That is, through the above-described correction of the work position, the robot control device 30 can cause the second robot 22 to carry out highly accurate work. The robot system 1 may have a configuration in which the first robot 21 includes the discharge unit D and the first robot 21 is caused to carry out both the first work and the second work. The robot system 1 may have a configuration in which the second robot 22 is caused to carry out both the first work and the second work. However, in order to shorten the cycle time, in the robot system 1, it is desirable that the first robot 21 carries out the first work and the second robot 22 carries out the second work.

The robot control device 30 causes the position of the discharge unit D to coincide with the corrected work position. The robot control device 30 causes the discharge unit D to discharge the grease. In this way, the robot control device 30 causes the first robot 21 to carry out the first work, and causes the second robot 22 to carry out the second work. In this manner, the above-described predetermined work is carried out by both the first robot 21 and the second robot 22.

In the following description, a process will be described in detail in which the robot control device 30 corrects each of the detection target position and the work position.

In the following description, as an example, a case will be described where a height of the first reference marker M1 is equal to a height of the object O. The height of the first reference marker M1 represents the position in the upward/downward direction, and represents the position of the centroid of the drawing illustrating the shape of the upper surface of the first reference marker M1. The height of the object O represents the position in the upward/downward direction, and represents the position of the centroid of the drawing illustrating the shape of the upper surface of the object O. In this case, the robot control device 30 can suppress an error based on a difference between the height of the first reference marker and the height of the detection target position, within errors in detecting the detection target position from the first image. The height of the first reference marker M1 may be different from the height of the object O.

Hardware Configuration of Robot Control Device

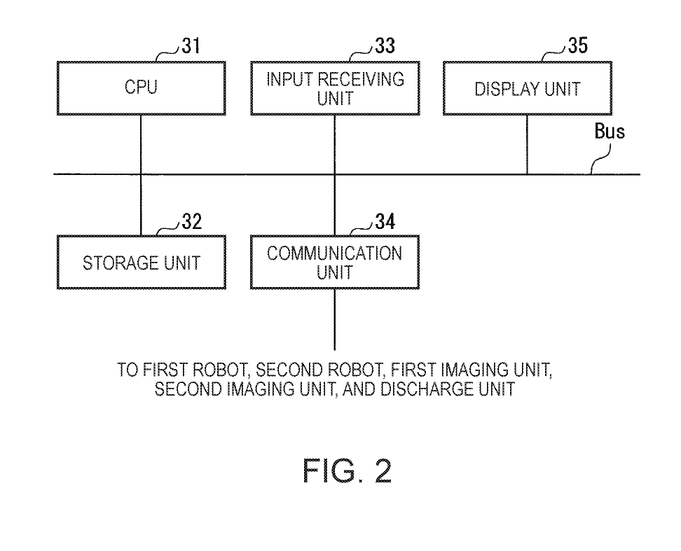

Hereinafter, referring to FIG. 2, a hardware configuration of the robot control device 30 will be described. FIG. 2 is a view illustrating an example of the hardware configuration of the robot control device 30.

For example, the robot control device 30 includes a central processing unit (CPU) 31, a storage unit (storage) 32, an input receiving unit (receiver) 33, a communication unit (communicator) 34, and a display unit (display) 35. These configuration elements are connected to and communicable with each other via a bus. The robot control device 30 communicates with each of the first robot 21, the second robot 22, the first imaging unit C1, the second imaging unit C2, and the discharge unit D via the communication unit 34.

The CPU 31 executes various programs stored in the storage unit 32.

For example, the storage unit 32 includes a hard disk drive (HDD), a solid state drive (SSD), an electrically erasable programmable read-only memory (EEPROM), a read-only memory (ROM), and a random access memory (RAM). Instead of those which are incorporated in the robot control device 30, the storage unit 32 may be an external storage device connected by a digital input/output port such as a USB. The storage unit 32 stores various types of information, various programs, and various images (including the above-described first image and second image) which are processed by the robot control device 30.

For example, the input receiving unit 33 is a keyboard, a mouse, a touch pad, and the other input device. The input receiving unit 33 may be a touch panel configured integrally with the display unit 35. The input receiving unit 33 may be separate from the robot control device 30. In this case, the input receiving unit 33 is connected to and communicable with the robot control device 30 via a wire or in a wireless manner.

For example, the communication unit 34 includes a digital input/output port such as a USB or an Ethernet (registered trademark) port.

For example, the display unit 35 is a liquid crystal display panel or an organic electro luminescence (EL) display panel. The display unit 35 may be separate from the robot control device 30. In this case, the display unit 35 is connected to and communicable with the robot control device 30 via a wire or in a wireless manner.

Functional Configuration of Robot Control Device

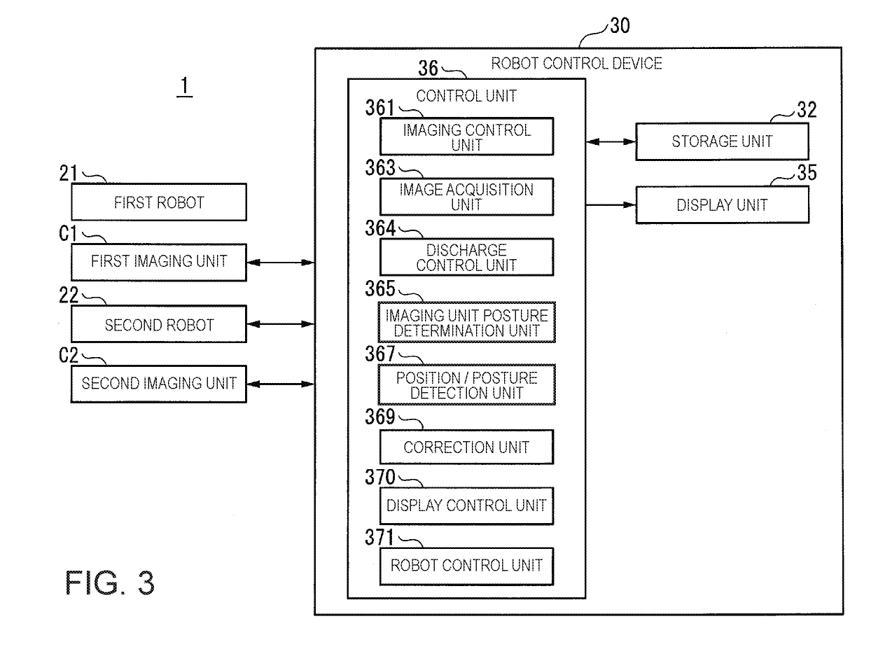

Hereinafter, referring to FIG. 3, a functional configuration of the robot control device 30 will be described. FIG. 3 is a view illustrating an example of the functional configuration of the robot control device 30.

The robot control device 30 includes the storage unit 32, the display unit 35, and a control unit 36.

The control unit 36 controls the overall robot control device 30. The control unit 36 includes an imaging control unit 361, an image acquisition unit 363, a discharge control unit 364, an imaging unit posture determination unit 365, a position/posture detection unit 367, a correction unit 369, a display control unit 370, and a robot control unit 371. For example, these functional units of the control unit 36 are realized by the CPU 31 executing various programs stored in the storage unit 32. The functional units may partially or entirely be hardware functional units such as large scale integration (LSI) and an application specific integrated circuit (ASIC).

The imaging control unit 361 causes the first imaging unit C1 to capture an image in a range which can be imaged by the first imaging unit C1. The imaging control unit 361 causes the second imaging unit C2 to capture an image in a range which can be imaged by the second imaging unit C2.

The image acquisition unit 363 acquires the first image captured by the first imaging unit C1 from the first imaging unit C1. The image acquisition unit 363 acquires the second image captured by the second imaging unit C2 from the second imaging unit C2.

The discharge control unit 364 causes the discharge unit D to discharge the grease.

The imaging unit posture determination unit 365 determines whether or not the posture of the first imaging unit C1 coincides with a first posture which is a predetermined posture. The imaging unit posture determination unit 365 determines whether or not the posture of the second imaging unit C2 coincides with a second posture which is a predetermined posture. The imaging unit posture determination unit 365 performs these determinations when the robot control device 30 adjusts the posture of the first imaging unit C1 and the posture of the second imaging unit C2 in the adjustments performed as preparations before the robot control device 30 causes both the first robot 21 and the second robot 22 to carry out the predetermined work. The adjustments will be described later.

The position/posture detection unit 367 detects the position and the posture of the object included in the first image, based on the first image acquired by the image acquisition unit 363 from the first imaging unit C1. The position/posture detection unit 367 detects the position and the posture of the object included in the second image, based on the second image acquired by the image acquisition unit 363 from the second imaging unit C2.

The correction unit 369 corrects the position detected by the position/posture detection unit 367. For example, the correction unit 369 corrects the above-described detection target position, and corrects the work position.

The display control unit 370 displays various types of information and various images on the display unit 35. For example, the display control unit 370 causes the display unit 35 to display information indicating a result determined by the imaging unit posture determination unit 365.

The robot control unit 371 operates the first robot 21. The robot control unit 371 operates the second robot 22. Adjustment of Posture of First Imaging Unit and Posture of Second Imaging Unit.

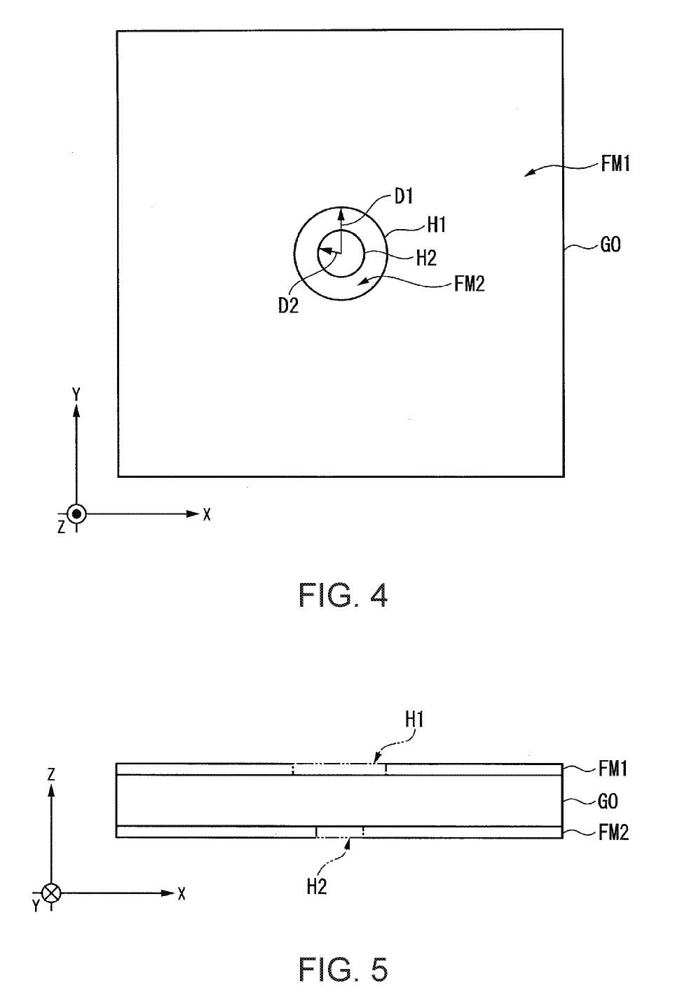

Hereinafter, referring to FIGS. 4 to 9, the adjustment of the posture of the first imaging unit C1 and the posture of the second imaging unit C2 will be described within the adjustments performed as preparations before the robot control device 30 causes both the first robot 21 and the second robot 22 to carry out the predetermined work. In the adjustment, the posture of the first imaging unit C1 is adjusted so that an optical axis of the first imaging unit C1 and the upper surface of the object O are orthogonal to each other. In this manner, the robot control device 30 can more accurately detect the position and the posture of the object included in the first image captured by the first imaging unit C1, compared to the detection before the adjustment is performed. In adjusting the posture of the first imaging unit C1 and the posture of the second imaging unit C2, the posture of the second imaging unit C2 is adjusted so that an optical axis of the second imaging unit C2 and the upper surface of the object O are orthogonal to each other. In this manner, the robot control device 30 can more accurately detect the position and the posture of the object included in the second image captured by the second imaging unit C2, compared to the detection before the adjustment is performed.

In adjusting the posture of the first imaging unit C1 and the posture of the second imaging unit C2, instead of the object O, a calibration object GO illustrated in FIGS. 4 and 5 is disposed on the upper surface of the work table TB. The calibration object GO in this example is a square flat plate. The calibration object GO may be an object having other shapes instead of the square flat plate. A material of the calibration object GO is quartz glass in this example. The material of the calibration object GO may be other materials instead of the quartz glass. FIG. 4 is a top view illustrating an example of the calibration object GO. In the three-dimensional orthogonal coordinate system illustrated in FIG. 4, the positive direction of the Z-axis coincides with the upward direction in the directions orthogonal to the upper surface of the calibration object GO. The direction extending along the X-axis coincides with the direction extending along one side of four sides belonging to the upper surface of the calibration object GO having a square shape. The direction extending along the Y-axis coincides with the direction extending along one side orthogonal to the one side of the four sides. That is, FIG. 4 is a view when the calibration object GO is viewed in the negative direction of the Z-axis. FIG. 5 is a side view when the calibration object GO is viewed in the positive direction of the Y-axis in the three-dimensional orthogonal coordinate system illustrated in FIG. 4.

As illustrated in FIGS. 4 and 5, a photomask FM1 is affixed to a first surface which is the upper surface of the calibration object GO. In this example, the photomask FM1 has a shape and a size which are the same as a shape and a size of the first surface of the calibration object GO. A circular hole portion having the size of a radius D1 whose circle center is the center of the photomask FM1 is formed as a first calibration marker H1. A photomask FM2 is affixed to a second surface which is the lower surface of the calibration object GO. In this example, the photomask FM2 has a shape and a size which are the same as a shape and a size of the second surface of the calibration object GO. A circular hole portion having the size of a radius D2 whose circle center is the center of the photomask FM2 is formed as a second calibration marker H2. Here, the radius D2 is smaller than the radius D1. That is, as illustrated in FIGS. 4 and 5, in a case where the calibration object GO is viewed in the negative direction of the Z-axis in the three-dimensional orthogonal coordinate system illustrated in FIG. 4, both the first calibration marker H1 and the second calibration marker H2 are visible. The reason is that the material of the calibration object GO is quartz glass. The shape of the first calibration marker H1 may be other shapes such as a rectangular shape and a cross shape, instead of the circular shape. Instead of a configuration in which the first calibration marker H1 is formed in the photomask FM1 affixed to the calibration object GO, a configuration may be adopted in which the first calibration marker H1 is formed in the calibration object GO. In this case, in the calibration object GO, the first calibration marker H1 has to be detectable by the robot control device 30. Therefore, for example, the calibration object GO may be an opaque object, or may be configured so that a portion of the first calibration marker H1 is colored. Alternatively, any configuration may be adopted as long as the first calibration marker H1 can be detected by the robot control device 30. Instead of the circular shape, the shape of the second calibration marker H2 may be other shapes such as a rectangular shape and a cross shape. Instead of a configuration in which the second calibration marker H2 is formed in the photomask FM2 affixed to the calibration object GO, a configuration may be adopted in which the second calibration marker H2 is formed in the calibration object GO. In this case, in the calibration object GO, the second calibration marker H2 has to be detectable by the robot control device 30. Therefore, for example, the calibration object GO may be an opaque object, or may be configured so that a portion of the second calibration marker H2 is colored. Alternatively, any configuration may be adopted as long as the second calibration marker H2 can be detected by the robot control device 30. Instead of a configuration in which the second calibration marker H2 is located on the second surface of the calibration object GO, a configuration may be adopted in which the second calibration marker H2 is located on the first surface of the calibration object GO together with the first calibration marker H1. In this case, the first surface of the calibration object GO has a surface on which the second calibration marker H2 is located and a surface on which the first calibration marker H1 is located which has a different position (that is, the height) in the direction extending along the Z-axis in the three-dimensional orthogonal coordinate system illustrated in FIG. 4.

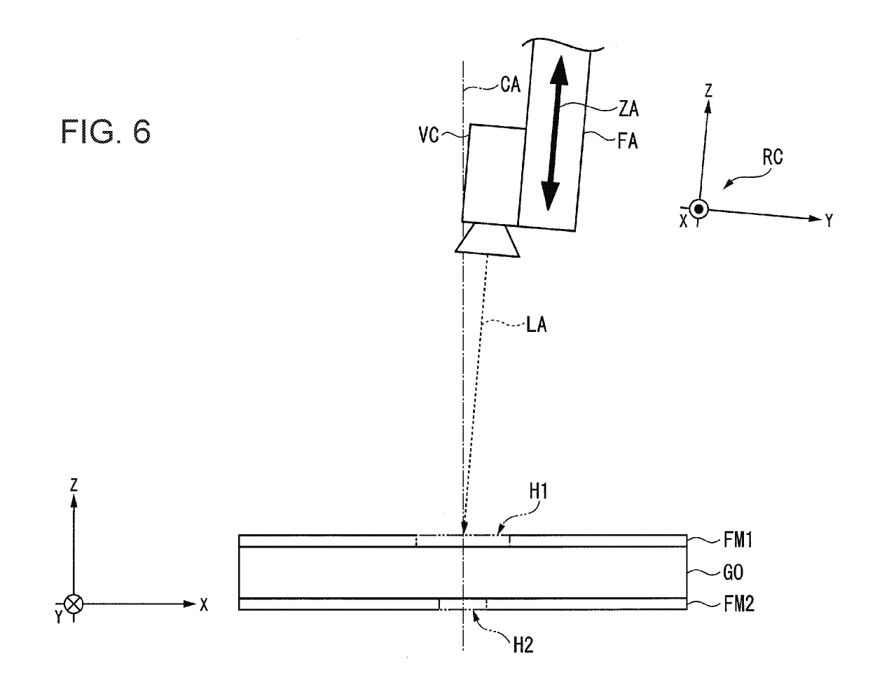

Next, referring to FIG. 6, a method of adjusting the posture of the first imaging unit C1 and the posture of the second imaging unit C2 will be described. FIG. 6 is a view for describing the method of adjusting the posture of the first imaging unit C1 and the posture of the second imaging unit C2. Here, in order to describe the method, description will be made by using a virtual imaging unit VC illustrated in FIG. 6 as an example, instead of the first imaging unit C1 and the second imaging unit C2. An arrow LA illustrated in FIG. 6 represents the optical axis of the imaging unit VC. In FIG. 6, the imaging unit VC is attached to a member FA. The member FA translates the imaging unit VC in the direction ZA along the Z-axis in the robot coordinate system RC in response to an instruction from the robot control device 30. In the following description, in order to describe the method, the following case will be described. At a timing before the posture of the imaging unit VC is adjusted, the Z-axis in the robot coordinate system RC and the optical axis of the imaging unit VC are not parallel to each other, and the direction extending along the Z-axis and the direction orthogonal to the first surface of the calibration object GO are not parallel to each other.

In the method of adjusting the posture of the imaging unit VC, the calibration object GO is installed on the upper surface of the work table TB by a user so that the optical axis of the imaging unit VC passes through the center of the first surface of the calibration object GO. For example, the display control unit 370 displays an image captured by the imaging unit VC together with information indicating the center of the captured image, that is, information indicating a position through which the optical axis passes. The display control unit 370 updates the image and the information each time a predetermined cycle elapses. That is, each time the cycle elapses, the imaging control unit 361 causes the imaging unit VC to capture the image in the range which can be imaged by the imaging unit VC. For example, the cycle is 0.1 seconds. The image acquisition unit 363 acquires an image captured by the imaging unit VC each time the cycle elapses. Each time the display control unit 370 acquires the image from the imaging unit VC, the display control unit 370 causes the display unit 35 to display the information together with the image. In this manner, while viewing the image and the information, the user can install the calibration object GO on the upper surface of the work table TB so that the optical axis passes through the center of the calibration object GO. The cycle may be shorter than 0.1 second, or may be longer than 0.1 second. For example, the information is two straight lines orthogonal to each other at the position through which the optical axis passes in the image. The information may be other information indicating the position. In a case where the work table TB can be moved by the robot control device 30, a configuration may be adopted in which the robot control device 30 moves the work table TB so that the information and the center of the first surface of the calibration object GO detected from the image coincide with each other.

After the calibration object GO is installed on the upper surface of the work table TB so that the center of the calibration object GO passes through the optical axis of the imaging unit VC, in a case where directions indicated by an arrow ZA and an arrow LA are not parallel to each other, the position of the calibration object GO inside the image captured by the imaging unit VC is changed in response to the translation of the imaging unit VC along the Z-axis in the robot coordinate system RC. Therefore, while viewing the image displayed on the display unit 35 and captured by the imaging unit VC, the user adjusts an attachment position of the imaging unit VC to be attached to the member FA, and adjusts the posture of the imaging unit VC so that the position is not changed in response to the translation. In this manner, the user can cause the optical axis of the imaging unit VC to be parallel to the direction extending along the Z-axis in the robot coordinate system RC. The robot control device 30 may be configured to change the posture of the imaging unit VC so that the position is not changed in response to the translation. In this case, the imaging unit VC is attached to the member FA via a drive unit which can change the posture of the imaging unit VC.

Next, the user adjusts the posture of the imaging unit VC so that the optical axis of the imaging unit VC is orthogonal to the first surface of the calibration object GO. At this time, the user adjusts the posture of the imaging unit VC while maintaining a state where the z-axis in the robot coordinate system RC and the optical axis of the imaging unit VC are parallel to each other. For example, the user adjusts the posture of the imaging unit VC by adjusting the posture of the robot (that is, in this example, a virtual robot including the member FA) including the imaging unit VC. Without adjusting the posture of the robot, the user may adjust the posture of the imaging unit VC while maintaining the state where the Z-axis in the robot coordinate system RC and the optical axis of the imaging unit VC are parallel to each other.

Here, the imaging control unit 361 causes the imaging unit VC to capture the image in the imaging range which can be imaged by the imaging unit VC, based on an operation received from the user. The image acquisition unit 363 acquires the image captured by the imaging unit VC as a third image, from the imaging unit VC. Thereafter, the user rotates the calibration object GO as large as 180° around the axis passing through the center of the calibration object GO on the upper surface of the work table TB. At this time, the user rotates the calibration object GO while viewing the image displayed on the display unit 35 and captured by the imaging unit VC. Based on the operation received from the user, the imaging control unit 361 causes the imaging unit VC to capture the image in the imaging range. The image acquisition unit 363 acquires the captured image as a fourth image, from the imaging unit VC. In a case where the work table TB can be moved by the robot control device 30, the robot control device 30 may be configured to move the work table TB so that the calibration object GO is rotated as large as 180° around the axis passing through the center of the calibration object GO on the upper surface of the work table TB.

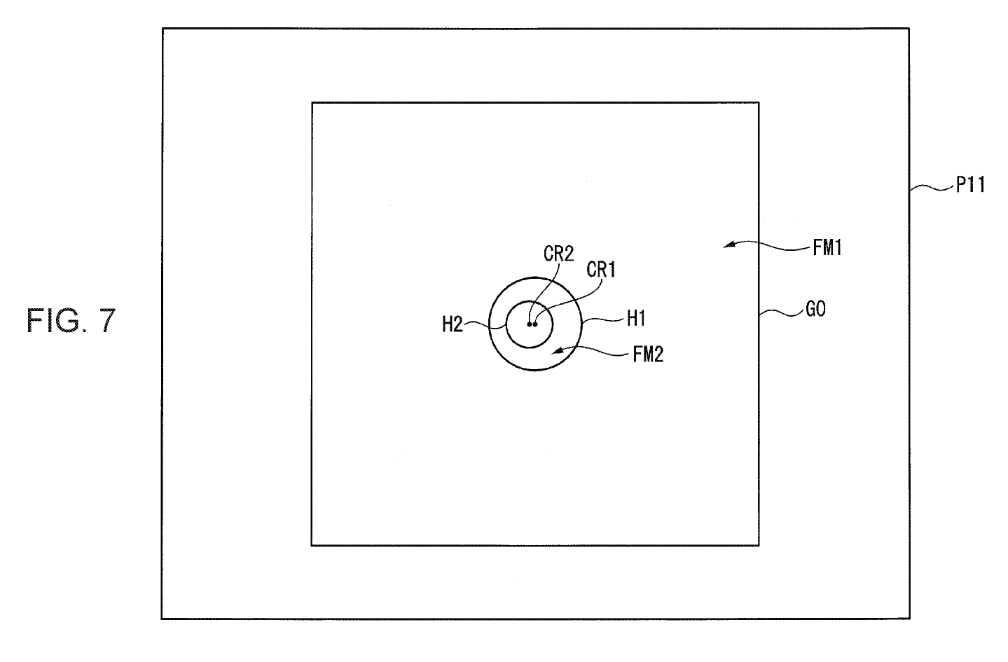

FIG. 7 is a view illustrating an example of the third image. An image P11 illustrated in FIG. 7 is an example of the third image. Based on the third image acquired from the imaging unit VC, the position/posture detection unit 367 detects each of a position CRI of the centroid (in this example, the center of the first calibration marker H1 having a circular shape) of the first calibration marker H1 and a position CR2 of the centroid (in this example, the center of the second calibration marker H2 having a circular shape) of the second calibration marker H2. In a case where the optical axis of the imaging unit VC and the first surface of the calibration object GO are not orthogonal to each other, as illustrated in FIG. 7, the position CR1 and the position CR2 do not coincide with each other in the image P11. Here, each of the position CR1 and the position CR2 is located on the third image.

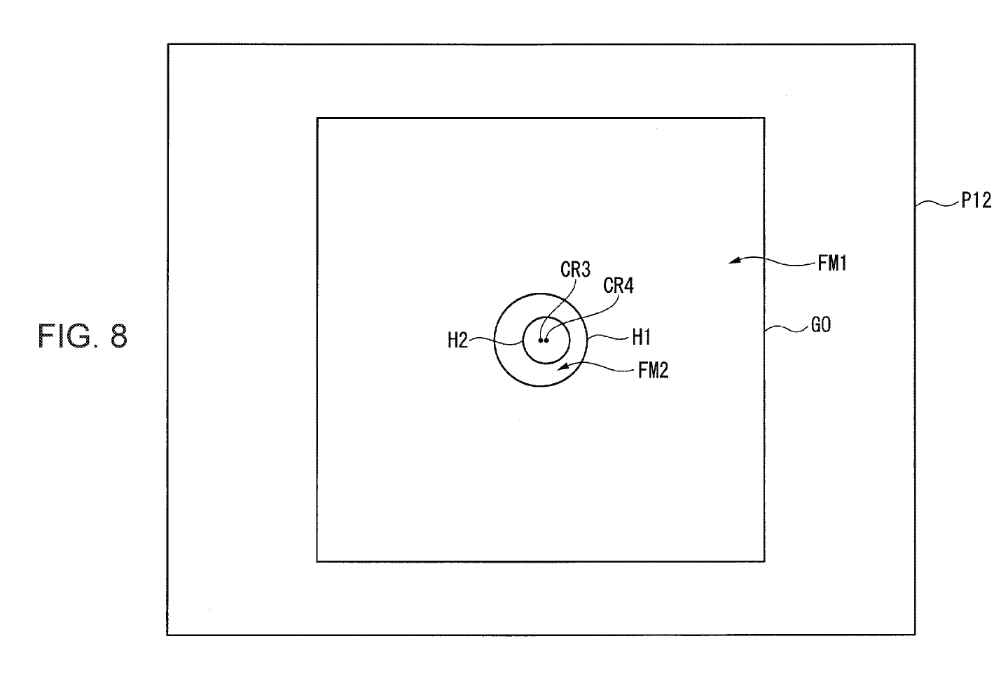

FIG. 8 is a view illustrating an example of a fourth image. An image P12 illustrated in FIG. 8 is an example of the fourth image. Based on the fourth image acquired from the imaging unit VC, the position/posture detection unit 367 detects each of a position CR3 of the centroid (in this example, the center of the first calibration marker H1 having a circular shape) of the first calibration marker H1 and a position CR4 of the centroid (in this example, the center of the second calibration marker H2 having a circular shape) of the second calibration marker H2. In a case where the optical axis of the imaging unit VC and the first surface of the calibration object GO are orthogonal to each other, as illustrated in FIG. 8, the position CR3 and the position CR4 do not coincide with each other in the image P12. Here, each of the position CR3 and the position CR4 is located on the fourth image.

The imaging unit posture determination unit 365 determines whether or not both the number of pixels representing a difference between the position CR1 and the position CR3 and the number of pixels representing a difference between the position CR2 and the position CR4 are less than a predetermined number of pixels. In this manner, the imaging unit posture determination unit 365 determines whether or not the posture of the imaging unit VC is the predetermined posture. In the following description, as an example, a case will be described where the predetermined number of pixels is one pixel. The predetermined number of pixels may be a smaller than one pixel, or may be more than one pixel. In a case where both the number of pixels representing the difference between the position CR1 and the position CR3 and the number of pixels representing the difference between the position CR2 and the position CR4 are smaller than one pixel, the optical axis of the imaging unit VC and the first surface of the calibration object GO are substantially orthogonal to each other. In a case where the imaging unit posture determination unit 365 determines that both of these are more than one pixel, the imaging unit posture determination unit 365 determines that the posture of the imaging unit VC is not the predetermined posture. The display control unit 370 causes the display unit 35 to display information indicating that the posture of the imaging unit VC is not the predetermined posture, as information indicating a result determined by the imaging unit posture determination unit 365. On the other hand, in a case where the imaging unit posture determination unit 365 determines that both of these are smaller than one pixel, the imaging unit posture determination unit 365 determines that the posture of the imaging unit VC is the predetermined the posture. The display control unit 370 causes the display unit 35 to display information indicating that the posture of the imaging unit VC is the predetermined posture, as information indicating a result determined by the imaging unit posture determination unit 365. In this way, based on the information displayed on the display unit 35 and the information indicating the result determined by the imaging unit posture determination unit 365, the user can recognize whether or not the posture of the imaging unit VC is the predetermined posture. Therefore, while viewing the information, the user can adjust the posture of the imaging unit VC so that the optical axis of the imaging unit VC and the first surface of the calibration object GO are substantially orthogonal to each other. The imaging unit posture determination unit 365 may be configured to determine whether or not any one of the number of pixels representing the difference between the position CR1 and the position CR3 and the number of pixels representing the difference between the position CR2 and the position CR4 is smaller than the predetermined number of pixels, thereby determining whether or not the posture of the imaging unit VC is the predetermined posture. In this manner, a configuration may be adopted in which the robot control device 30 may be configured to change the posture of the imaging unit VC while maintaining a state where the Z-axis in the robot coordinate system RC and the optical axis of the imaging unit VC are parallel to each other, so that both the number of pixels representing the difference between the position CR1 and the position CR3 and the number of pixels representing the difference between the position CR2 and the position CR4 are smaller than the predetermined number of pixels. In this case, the member FA includes a drive unit which can change the posture of the imaging unit VC while maintaining a state where the z-axis in the robot coordinate system RC and the optical axis of the imaging unit VC are parallel to each other.

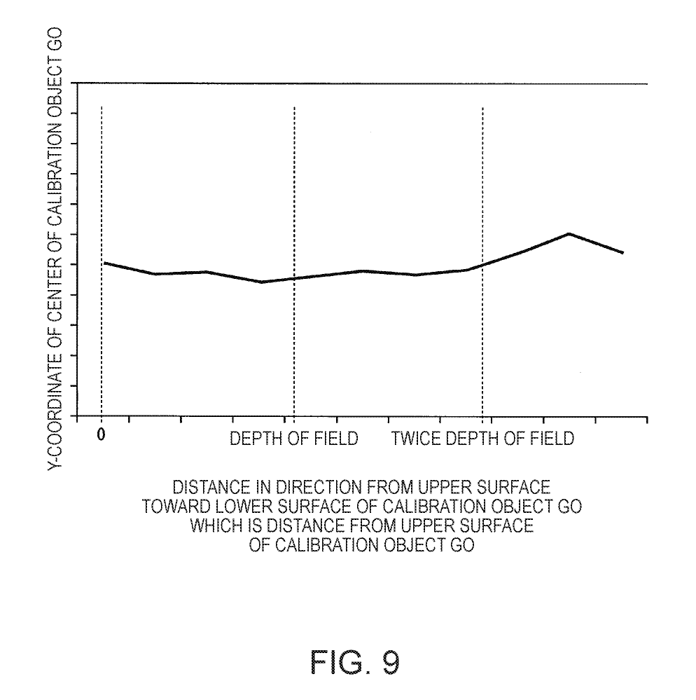

The distance between the first calibration marker H1 and the second calibration marker H2 described above, which is the distance (in this example, the thickness of the calibration object GO) in the direction extending along the optical axis of the imaging unit VC (that is, the imaging direction of the imaging unit VC) is the thickness corresponding to the depth of field of the imaging unit VC. FIG. 9 illustrates an example of a relationship between the distance from the first surface of the calibration object GO, which is the distance in the direction from the first surface toward the second surface of the calibration object GO and the Y-coordinate indicating the position of the center of the calibration object GO in the image captured by the imaging unit VC. The relationship between the distance and the X-coordinate indicating the position of the center and the relationship between the distance and the Y-coordinate indicating the position of the center are in the same tendency. Accordingly, description thereof will be omitted. As illustrated in FIG. 9, if the distance is equal to or smaller than twice the depth of field, a value of the Y-coordinate is substantially constant. However, if the distance exceeds twice the depth of field, the value of the Y coordinate is inevitably changed. The reason is that in a case where the distance exceeds twice the depth of field, the position of the center in the image is blurred without being focused. For this reason, it is desirable that the distance between the first calibration marker H1 and the second calibration marker H2 is equal to or smaller than twice the depth of field of the imaging unit VC. In a case where the distance between the first calibration marker H1 and the second calibration marker H2 is smaller than half of the depth of field, the difference between the position CR1 and the position CR3 and the difference between the position CR2 and the position CR4 are less likely to be detected by the robot control device 30. Therefore, it is desirable that the distance between the first calibration marker H1 and the second calibration marker H2 is equal to or longer than half of the depth of field. The distance between the first calibration marker H1 and the second calibration marker H2 may be shorter than half of the depth of field, or may exceed twice the depth of field.

The user can adjust the posture of the imaging unit VC By using the above-described method. This method is applicable to the adjustment of the posture of the first imaging unit C1 and the adjustment of the posture of the second imaging unit C2. That is, the user can adjust the posture of the first imaging unit C1, and can adjust the posture of the second imaging unit C2 by using the above-described method. In this manner, the robot control device 30 can more accurately detect the position of the object included in the first image captured by the first imaging unit C1, compared to a case where the posture of the first imaging unit C1 is not adjusted. The robot control device 30 can more accurately detect the position of the object included in the second image captured by the second imaging unit C2, compared to a case where the posture of the second imaging unit C2 is not adjusted.

Instead of the photomask, the photomask FM1 described above may be other objects as long as the objects have an opaque sheet shape and have the first calibration marker H1 formed therein. However, in a case where the object is imaged by each of the first imaging unit C1 and the second imaging unit C2, it is desirable that the object is imaged so that an edge representing an outline of the first calibration marker H1 is imaged without being blurred. Instead of the photomask, the photomask FM2 described above may be other objects as long as the objects have an opaque sheet shape and have the second calibration marker H2 formed therein. However, in a case where the object is imaged by each of the first imaging unit C1 and the second imaging unit C2, it is desirable that the object is imaged so that an edge representing an outline of the second calibration marker H2 is imaged without being blurred.

The photomask FM1 described above may be configured to be affixed to other surfaces, instead of the first surface of the calibration object GO. That is, the first calibration marker H1 may be configured to be disposed on other surfaces of the calibration object GO, instead of the first surface. The photomask FM2 described above may be configured to be affixed to other surfaces, instead of the second surface of the calibration object GO. That is, the second calibration marker H2 may be configured to be disposed on other surfaces of the calibration object GO, instead of the second surface. Process in which Robot Control Device Corrects Detection Target Position and Work Position.

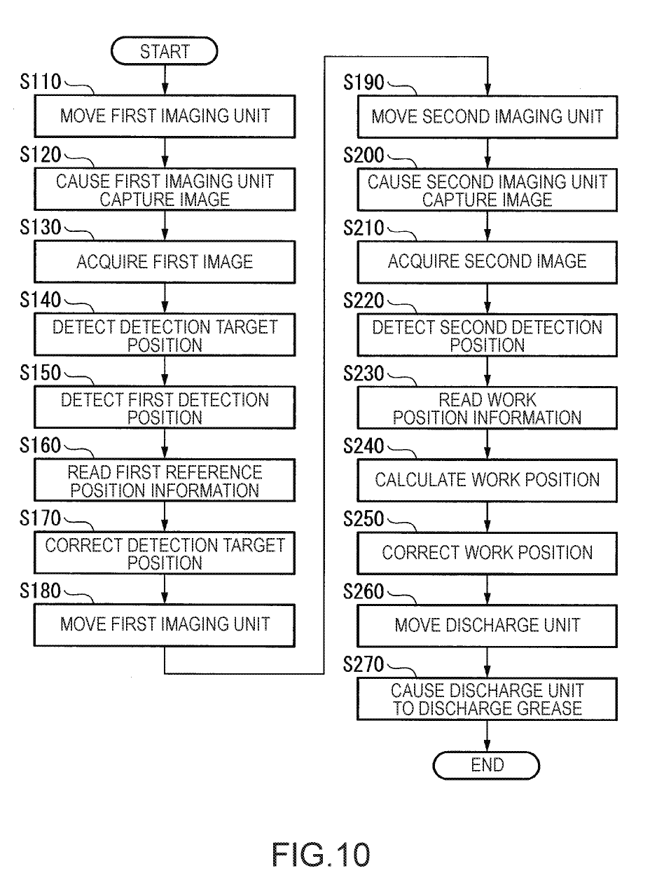

Hereinafter, referring to FIG. 10, a process will be described in which the robot control device 30 corrects the detection target position and the work position. FIG. 10 is a flowchart illustrating an example of the process in which the robot control device 30 corrects the detection target position and the work position.

The robot control unit 371 reads information stored in advance in the storage unit 32 and indicating the first imaging position and the first imaging posture, from the storage unit 32. The robot control unit 371 moves the first imaging unit C1 (that is, operates the first robot 21), and causes the position and the posture of the first imaging unit C1 to coincide with the first imaging position and the first imaging posture (Step S110). Next, the imaging control unit 361 causes the first imaging unit C1 to capture the image in the first imaging range which can be imaged by the first imaging unit C1 (Step S120). Next, the image acquisition unit 363 acquires the first image captured by the first imaging unit C1 from the first imaging unit C1 in Step S120 (Step S130).

Next, the position/posture detection unit 367 detects the position of the object O included in the first image, as the position detection target position, based on the first image acquired from the first imaging unit C1 by the image acquisition unit 363 in Step S130 (Step S140). For example, the position/posture detection unit 367 detects the position as the detection target position by using pattern matching. The position/posture detection unit 367 may be configured to detect the position as the detection target position by using other methods.

Next, the position/posture detection unit 367 detects the position of the first reference marker M1 on the first image, as the first detection position, based on the first image acquired by the image acquisition unit 363 from the first imaging unit C1 in Step S130 (Step S150). For example, the position/posture detection unit 367 detects the position, as the first detection position by using pattern matching. The position/posture detection unit 367 may be configured to detect the position as the first detection position by using other methods. Here, a process in Step S150 will be described.

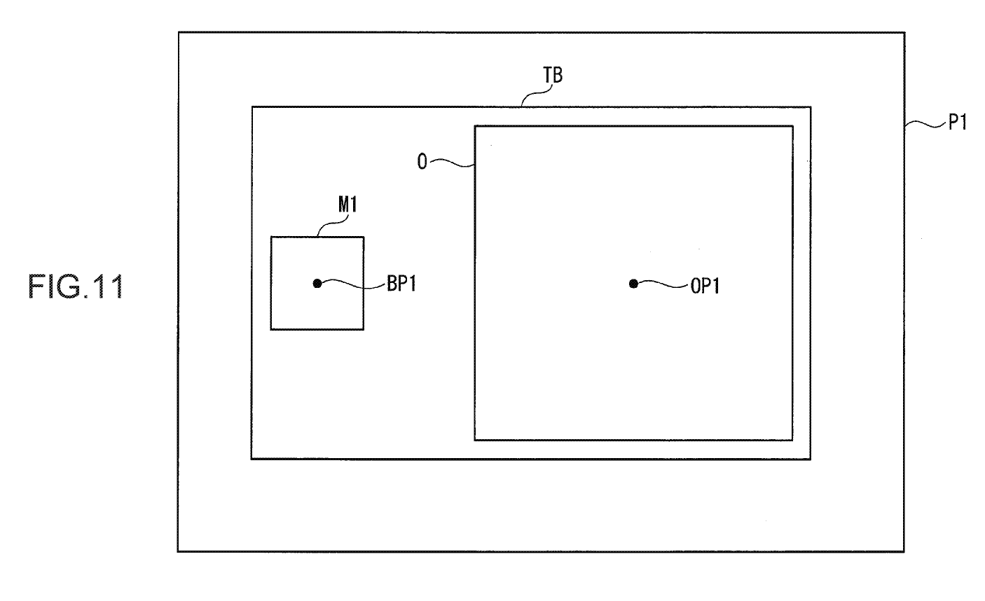

FIG. 11 is a view illustrating an example of the first image acquired by the image acquisition unit 363 in Step S140. An image P1 illustrated in FIG. 11 is an example of the first image. In the image P1, a range including the upper surface of the work table TB is imaged. That is, in the image P1, the upper surface, the object O placed on the upper surface, and the first reference marker M1 disposed on the upper surface are imaged. A point OP1 illustrated in FIG. 11 indicates the position of the object O on the image P1. A point BP1 illustrated in FIG. 11 indicates the position of the first reference marker M1 on the image P1. In Step S150, the position/posture detection unit 367 detects the position of the first reference marker M1 on the image P1, as the first detection position, based on the image P1.

After the process in Step S150 is performed, the correction unit 369 reads the first reference position information stored in advance in the storage unit 32, from the storage unit 32 (Step S160). Next, the correction unit 369 corrects the detection target position detected by the position/posture detection unit 367 in Step S140, based on the first detection position information indicating the first detection position detected by the position/posture detection unit 367 in Step S150 and the first reference position information read from the storage unit 32 in Step S160 (Step S170). Here, a process in Step S170 will be described.

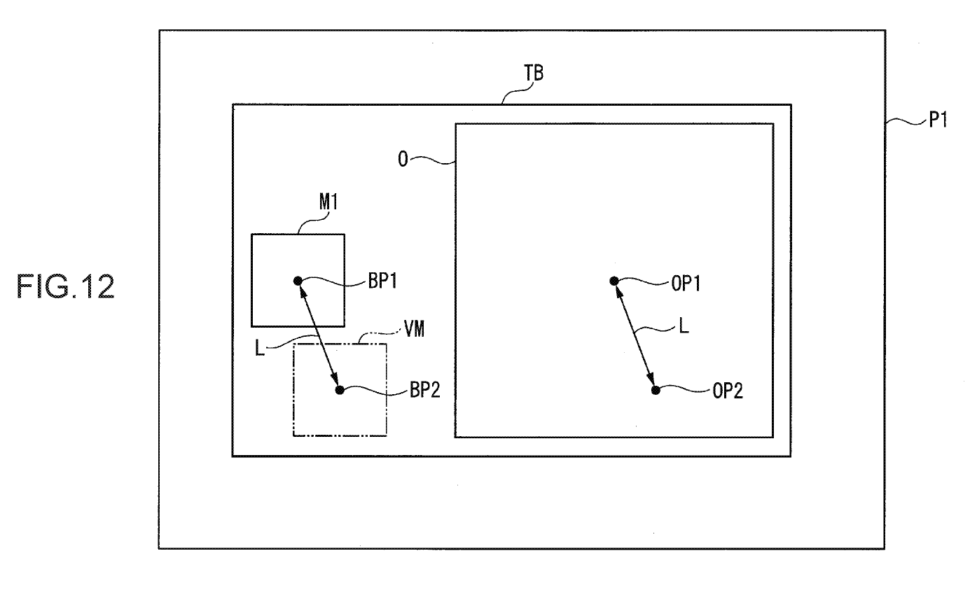

In some cases, as illustrated in FIG. 12, the first reference position indicated by the first reference position information may be misaligned with the first detect ion posit ion detected by the position/posture detection unit 367 in Step S150. FIG. 12 is a view illustrating an example of the misalignment between the first detection position and the first reference position indicated by the first reference position information on the image P1 illustrated in FIG. 11. A frame VM illustrated in FIG. 12 indicates an outline of the first reference marker M1 on the image P1 in a case where the position and the posture of the first imaging unit C1 coincide with the first imaging position and the first imaging posture without misalignment therebetween. A point BP2 illustrated in FIG. 12 indicates the first detection position in this case. If the first detection position indicated by the point BP2 is converted into the position in the robot coordinate system RC, the converted first detection position coincides with the first reference position. That is, the first detection position detected by the position/posture detection unit 367 in Step S150 is misaligned with the first reference position. A difference L illustrated in FIG. 12 indicates a difference between the first detection position and the first reference position.

Here, as described above, the difference L is generated due to reasons such as insufficient rigidity of a member (for example, each of the first frame F1 to the third frame F3) configuring the first robot 21, insufficient rigidity associated with an attachment structure of the first imaging unit C1 attached to the first robot 21, and thermal expansion of each actuator included in the first robot 21. Therefore, in a case where the detection target position detected by the position/posture detection unit 367 is converted into the position in the robot coordinate system RC in Step S140, as illustrated in FIG. 12, the converted detection target position is misaligned as much as the difference L with the actual position of the object O in the robot coordinate system RC. A point OP2 illustrated in FIG. 12 indicates the position of the object O on the image P1 in a case where the position and the posture of the first imaging unit C1 coincide with the first imaging position and the first imaging posture without misalignment therebetween.

Therefore, the correction unit 369 converts the first detection position detected by the position/posture detection unit 367 in Step S150 into the position in the robot coordinate system. RC. The correction unit 369 calculates the difference L between the first detection position converted into the position in the robot coordinate system RC and the first reference position indicated by the first reference position information read from the storage unit 32. The correction unit 369 corrects the detection target position by shifting the detection target position detected by the position/posture detection unit 367 in Step S140 as much as the calculated difference L. The correction unit 369 may be configured to correct the detection target position by calculating the detection target position in the robot coordinate system RC where the origin is shifted as much as the difference L. The correction unit 369 may be configured to correct the detection target position by using other methods based on the difference L.

After the process in Step S170 is performed, the robot control unit 371 operates the first robot 21, and moves the first imaging unit C1 to a region which does not overlap the work region of the second robot 22 within the work region of the first robot 21 (Step S180). Next, the robot control unit 371 moves the second imaging unit C2 (that is, operates the second robot 22), and causes the position and the posture of the second imaging unit C2 to coincide with the first imaging position and the first imaging posture (Step S190). Next, the imaging control unit 361 causes the second imaging unit C2 to capture the image in the second imaging range which can be imaged by the second imaging unit C2 (Step S200). Next, the image acquisition unit 363 acquires the second image captured by the second imaging unit C2 in Step S200, from the second imaging unit C2 (Step S210).

Next, the position/posture detection unit 367 detects the position of the first reference marker M1 included in the second image, as the second detection position, based on the second image acquired by the image acquisition unit 363 from the second imaging unit C2 in Step S210 (Step S220). For example, the position/posture detection unit 367 detects the position as the second detection position by using pattern matching. The position/posture detection unit 367 may be configured to detect the position as the second detection position by using other methods.

Next, the correction unit 369 reads the work position information stored in advance in the storage unit 32, from the storage unit 32 (Step S230). The work position information indicates the relative position from the detection target position corrected in Step S170 to the work position.

Next, the correction unit 369 calculates the work position in the robot coordinate system RC, based on the work position information read from the storage unit 32 in Step S230 and the detection target position corrected in Step S170 (Step S240).

Next, the correction unit 369 converts the second detection position detected by the position/posture detection unit 367 in Step S220 into a position in the robot coordinate system RC. The correction unit 369 calculates a difference between the second detection position converted into the position in the robot coordinate system RC and the first reference position indicated by the first reference position information read from the storage unit 32 in Step S160. The correction unit 369 corrects the work position by shifting the work position calculated in Step S240 as much as the calculated difference (Step S250). The process in Step S250 is similar to the process in Step S170, and thus, detailed description thereof will be omitted. The correction unit 369 may be configured to correct the work position by calculating the work position in the robot coordinate system RC whose origin is shifted as much as the difference. The correction unit 369 may be configured to correct the work position by other methods based on the difference.

Next, the robot control unit 371 moves the discharge unit D (that is, operates the second robot 22), and causes the position of the discharge unit D to coincide with the work position corrected in Step S250 (Step S260). Next, the discharge control unit 364 discharges the grease to a position where the discharge unit D can discharge the grease (Step S270). That is, in Step S270, the robot control unit 371 causes the second robot 22 to carry out the second work. Thereafter, the control unit 36 completes the process.

The robot coordinate system RC described above is an example of the first coordinate system. In the present embodiment, the robot coordinate system RC may be replaced with other coordinate systems.

In the flowchart described above, Step S250 may be omitted.

The robot control device 30 may be configured not to cause the second robot 22 to carry out the second work. In this case, the robot control device 30 performs other processes based on the detection target position corrected in Step S170.

In a case where the robot control device 30 performs the above-described processes in the flowcharts for each of the plurality of objects O, that is, in a case where the second robot 22 is caused to carry out the second work multiple times in the processes, a configuration may be adopted in which the process in Step S250 is performed as many as less than the multiple times. That is, the robot control device 30 does not need to perform the process in Step S250 each time the second robot 22 carries out the second work for each of the plurality of objects O in the process of the flowchart. For example, in a case where the second robot 22 is caused to carry out the second work multiple times in the process of the flowchart, a configuration may be adopted in which the robot control device 30 performs the process in Step S250 each time the second work carries out a predetermined number of times. In a case where the second robot 22 carries out the second work multiple times in the process of the flowchart, the robot control device 30 may be configured to perform the process in Step S250 multiple times.

In the robot system. 1, a configuration may be adopted in which the above-described adjustment of the posture of the first imaging unit C1 and the posture of the second imaging unit C2 may not be performed. In this case, the imaging unit posture determination unit 365 included in the robot control device 30 does not perform the above-described determination.

As described above, the robot control device 30 detects the detection target position which is the position of the detection target (in this example, the object O), from the first image captured by the first imaging unit (in this example, the first imaging unit C1) disposed in the first robot (in this example, the first robot 21). The robot control device 30 corrects the detection target position, based on the first reference position information indicating the first reference position serving as the reference position of the first reference marker which is the information stored in advance in the storage unit (in this example, the storage unit 32) and the first detection position information indicating the first detection position serving as the position of the first reference marker (in this example, the first reference marker M1) included in the first image, which is the position detected based on the first image. In this manner, the robot control device 30 can perform a highly accurate process based on the corrected detection target position.

The robot control device 30 converts the first detection position into the position in the first coordinate system (in this example, the robot coordinate system RC), and corrects the detection target position, based on the difference between the converted first detection position and the first reference position. In this manner, based on the difference between the first detection position converted into the position in the first coordinate system and the first reference position, the robot control device 30 can perform a highly accurate process based on the corrected detection target position.

In the robot control device 30, the height of the first reference position is equal to the height of the detection target position. In this manner, the robot control device 30 can suppress an error based on the difference between the height of the first reference marker and the height of the detection target position, within errors in detecting the detection target position from the first image.

The robot control device 30 causes the second robot (in this example, the second robot 22) to carry out the work (in this example, the second work) at the work position based on the detection target position. In this manner, the robot control device 30 can cause the second robot to carry out highly accurate work.

The robot control device 30 corrects the work position, based on the second reference position information indicating the second reference position (in this example, the first reference position) serving as the reference position of the second reference marker (in this example, the first reference marker M1) which is the information stored in advance in the storage unit and the second detection position information indicating the second detection position serving as the position of the second reference marker included in the second image, which is the position detected based on the second image captured by the second imaging unit (in this example, the second imaging unit C2) disposed in the second robot. In this manner, the robot control device 30 can cause the second robot to carry out highly accurate work, based on the corrected work position.

In a case where the second robot is caused to carry out the work multiple times, the robot control device 30 corrects the work position as many as less than the multiple times. In this manner, the robot control device 30 can shorten a time required for the work to be repeatedly carried out by the second robot.

The robot control device 30 determines whether or not the posture of the imaging unit is the predetermined posture, based on the image obtained by causing the imaging unit to image the first calibration marker (in this example, the first calibration marker H1) and the second calibration marker (in this example, the second calibration marker H2) located at the position different from the position of the first calibration marker in the imaging direction of the imaging unit (for example, each of the first imaging unit C1 and the second imaging unit C2) connected to the robot control device 30. In this manner, the robot control device 30 can assist posture adjustment of the imaging unit connected to the robot control device 30.

In the robot control device 30, the first calibration marker is disposed on the first surface of the object, and the second calibration marker is disposed on the second surface different from the first surface of the object. In this manner, based on the first calibration marker disposed on the first surface of the object and the second calibration marker disposed on the second surface of the object, the robot control device 30 can assist posture adjustment of the imaging unit connected to the robot control device 30.

In the robot control device 30, the distance between the first calibration marker and the second calibration marker is equal to or longer than half of the depth of field of the imaging unit connected to the robot control device 30, and is equal to or shorter than twice the depth of field. In this manner, the robot control device 30 can assist posture adjustment of the imaging unit connected to the robot control device 30, based on the second calibration marker located away from the first calibration marker as far as the distance equal to or longer than half of the depth of field of the imaging unit connected to the robot control device 30 and equal to or shorter than twice the depth of field of the imaging unit, and the first calibration marker.

Hitherto, the embodiment according to the invention has been described in detail with reference to the drawings. However, a specific configuration is not limited to this embodiment, and various modifications, substitutions, and deletions may be made without departing from the gist of the invention.

A program for realizing a function of any desired configuration unit in the above-described device (for example, the robot control device 30) may be recorded on a computer-readable recording medium so that a computer system reads and executes the program. The “computer system” described herein includes an operating system (OS) or hardware such as peripheral devices. The “computer-readable recording medium” means a storage device such as a flexible disk, a magneto-optical disk, a portable medium such as a ROM, a compact disk (CD)-ROM, and a hard disk incorporated in the computer system. Furthermore, the “computer-readable recording medium” includes those which hold a program for certain period of time, such as a volatile memory (RAM) inside the computer system serving as a server or a client in a case where the program is transmitted via a network such as the Internet or a communication line such as a telephone line.

The above-described program may be transmitted from the computer system having the program stored in a storage device to another computer system via a transmission medium or by using a transmission wave in the transmission medium. Here, the “transmission medium” for transmitting the program means a medium having a function to transmit information as in the network (communication network) such as the Internet and the communication line (communication cable) such as the telephone line.

The above-described program may partially realize the above-described function. Furthermore, the above-described program may be a so-called difference file (difference program) which can realize the above-described function in combination with the program previously recorded in the computer system.

The entire disclosure of Japanese Patent Application No. 2017-060598, filed Mar. 27, 2017 is expressly incorporated by reference herein.

What is claimed is:

1. A robot control device for detecting a detection target position, which is a position of a detection target, from a first image obtained by causing a first camera disposed in a first robot to image the detection target, the device comprising:
a processor that is configured to execute computer-executable instructions so as to control the first robot,
wherein the processor is configured to detect the detection target position from the first image, and that correct the detection target position, based on first reference position information stored in advance in a storage and indicating a first reference position which is a reference position of a first reference marker, and first detection position information indicating a first detection position which is a position detected based on the first image and which is a position of the first reference marker included in the first image.

2. The robot control device according to claim 1,
wherein the first reference position is a position in a first coordinate system, and
wherein the processor is configured to convert the first detection position into the position in the first coordinate system, and correct the detection target position, based on a difference between the converted first detection position and the first reference position.

3. The robot control device according to claim 1,
wherein a height of the first reference marker is equal to a height of the detection target position.

4. The robot control device according to claim 1,
wherein the processor is configured to cause a second robot to carry out work at a work position based on the detection target position.

5. The robot control device according to claim 4,
wherein the processor is configured to correct the work position, based on second reference position information stored in advance in the storage and indicating a second reference position which is a reference position of a second reference marker, and a second detection position information indicating a second detection position which is a position detected based on a second image captured by a second camera disposed in the second robot and which is a position of the second reference marker included in the second image.

6. The robot control device according to claim 5,
wherein in a case where the processor is configured to cause the second robot to carry out the work multiple times, the processor is configured to correct the work position less number of times than the multiple times.

7. The robot control device according to claim 1,
wherein the processor is configured to determine whether or not a posture of an camera is a predetermined posture, based on an image obtained by causing the camera to image a first calibration marker and a second calibration marker located at a position different from a position of the first calibration marker in an imaging direction of the camera connected to the robot control device.

8. The robot control device according to claim 7,
wherein the first calibration marker is disposed on a first surface of an object, and
wherein the second calibration marker is disposed on a second surface different from the first surface of the object.

9. The robot control device according to claim 7,
wherein a distance between the first calibration marker and the second calibration marker is equal to or longer than half of a depth of field of the camera, and is equal to or shorter than twice the depth of field of the camera.

10. A robot system comprising:
a first robot; and
the control device for detecting a detection target position, which is a position of a detection target, from a first image obtained by causing a first camera disposed in the first robot to image the detection target, the control device comprises a processor that is configured to execute computer-executable instructions so as to control the first robot;
wherein the processor is configured to detect the detection target position from the first image, and that correct the detection target position, based on first reference position information stored in advance in a storage and indicating a first reference position which is a reference position of a first reference marker, and first detection position information indicating a first detection position which is a position detected based on the first image and which is a position of the first reference marker included in the first image.

11. The robot system according to claim 10,
wherein the first reference position is a position in a first coordinate system, and
wherein the processor is configured to convert the first detection position into the position in the first coordinate system, and correct the detection target position, based on a difference between the converted first detection position and the first reference position.

12. The robot system according to claim 10,
wherein a height of the first reference marker is equal to a height of the detection target position.

13. The robot system according to claim 10,
wherein the processor is configured to cause a second robot to carry out work at a work position based on the detection target position.

14. The robot system according to claim 13,
wherein the processor is configured to correct the work position, based on second reference position information stored in advance in the storage and indicating a second reference position which is a reference position of a second reference marker, and a second detection position information indicating a second detection position which is a position detected based on a second image captured by a second camera disposed in the second robot and which is a position of the second reference marker included in the second image.

15. The robot system according to claim 14,
wherein in a case where the processor is configured to cause the second robot to carry out the work multiple times, the processor is configured to correct the work position less number of times than the multiple times.

16. The robot system according to claim 10,
wherein the processor is configured to determine whether or not a posture of an camera is a predetermined posture, based on an image obtained by causing the camera to image a first calibration marker and a second calibration marker located at a position different from a position of the first calibration marker in an imaging direction of the camera connected to the robot control device.

17. The robot system according to claim 16,
wherein the first calibration marker is disposed on a first surface of an object, and
wherein the second calibration marker is disposed on a second surface different from the first surface of the object.

18. The robot system according to claim 16,
wherein a distance between the first calibration marker and the second calibration marker is equal to or longer than half of a depth of field of the camera, and is equal to or shorter than twice the depth of field of the camera.
